(19) United States
(12) Patent Application Publication
(10) Pub. No.: US 2025/0102936 A1
(43) Pub. Date: Mar. 27, 2025

(54) MANUFACTURING METHOD OF ELECTROSTATIC CHARGE IMAGE DEVELOPING TONER

(71) Applicant: FUJIFILM Business Innovation Corp., Tokyo (JP)

(72) Inventors: Yoshimasa FUJIHARA, Kanagawa (JP); Akira MATSUMOTO, Kanagawa (JP); Satoshi MIURA, Kanagawa (JP); Ryuta NAKANE, Kanagawa (JP)

(73) Assignee: FUJIFILM Business Innovation Corp., Tokyo (JP)

(21) Appl. No.: 18/762,643

(22) Filed: Jul. 3, 2024

(30) Foreign Application Priority Data
Sep. 26, 2023 (JP) 2023-164014

(51) Int. Cl. G03G 9/08; G03G 9/087

(52) U.S. Cl. CPC G03G 9/0804; G03G 9/08755

(57) ABSTRACT

A manufacturing method of an electrostatic charge image developing toner includes aggregating particles including binder resin particles in a dispersion to form aggregated particles and heating the aggregated particles to raise a temperature of the aggregated particles and fuse the aggregated particles, in which, in the fusing, after raising the temperature to equal to or higher than a glass transition temperature of a binder resin in the binder resin particles, while agitating a dispersion containing the aggregated particles, an agitating rotation speed in the agitation of the dispersion is decreased in a stepwise manner or in a continuous manner.

### CROSS-REFERENCE TO RELATED APPLICATIONS

This application is based on and claims priority under 35 USC 119 from Japanese Patent Application No. 2023-164014 filed Sep. 26, 2023.

### BACKGROUND

### (i) Technical Field

The present invention relates to a manufacturing method of an electrostatic charge image developing toner.

### (ii) Related Art

Currently, a method for visualizing image information, such as an electrophotographic method, has been used in various fields. In the electrophotographic method, charging and formation of an electrostatic charge image are carried out so that an electrostatic charge image is formed as image information on a surface of an image holder. A toner image is formed on the surface of the image holder using a developer containing a toner, transferred to a recording medium, and then fixed on the recording medium. Through these steps, the image information is visualized as an image.

For example, JP2022-145174A discloses a manufacturing method of an electrostatic charge image developing toner, the manufacturing method including an aggregating agent-mixing step of adding an aggregating agent to a dispersion containing a binder resin particles while circulating the dispersion between an agitated vessel and a disperser to which a mechanical shearing force is applied, and mixing the aggregating agent with the dispersion containing the binder resin particles; an aggregation step of heating the dispersion after the aggregating agent-mixing step to reduce a viscosity of the dispersion and form aggregated particles; and a coalescence step of heating the dispersion containing the aggregated particles to coalesce the aggregated particles together to form toner particles.

JP2008-268313A discloses a manufacturing method of toner particles, the manufacturing method including a granulation step of dispersing a raw material for a toner in an aqueous medium using an agitating unit, in which the agitating unit is an agitation equipment including at least a rotating shaft and an agitating blade, an agitating blade in which an angle α (°) between adjacent agitating blades with the rotating shaft as a center on a plane intersecting the rotating shaft perpendicularly is 100≤α≤140 is used, an agitating blade diameter d (m) and a granulating container inner diameter D (m) in which the granulation step is performed satisfy 0.05≤d/D≤0.35, and a relationship of 20≤A≤40 is satisfied in a case where a circumferential speed of the agitating blade is A (m/s).

In addition, JP2019-8042A discloses a manufacturing method of a toner, the manufacturing method including a step of aggregating a liquid by an emulsification aggregation method of agitating an aggregation liquid having a thixotropy index of 7 or more, that is defined by (Viscosity at shear rate of 1 s⁻¹)/(Viscosity at shear rate of 10 s⁻¹) in which the viscosity at a shear rate of 10 s⁻¹ is 1 Pa's or more, the manufacturing method including an aggregation step of agitating the aggregation liquid by a plurality of agitating blades, in which the agitating blades are rotated in a portion where a shear rate of 10 s⁻¹ or less is 50% by volume or less in a portion where a shear rate of 400 s⁻¹ or more is 1% by volume or less.

### SUMMARY

Aspects of non-limiting embodiments of the present disclosure relate to a manufacturing method of an electrostatic charge image developing toner, the method including a step of aggregating particles including binder resin particles in a dispersion to form aggregated particles, and a step of heating the aggregated particles to raise a temperature of the aggregated particles and fuse the aggregated particles, in which generation of coarse particles is reduced as compared with a case where, in the fusing step, after raising the temperature to equal to or higher than a glass transition temperature of a binder resin in the binder resin particles, while agitating a dispersion containing the aggregated particles, an agitating rotation speed in the agitation of the dispersion is not changed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present invention, there is provided a manufacturing method of an electrostatic charge image developing toner, including aggregating particles including binder resin particles in a dispersion to form aggregated particles and heating the aggregated particles to raise a temperature of the aggregated particles and fuse the aggregated particles, in which, in the fusing, after raising the temperature to equal to or higher than a glass transition temperature of a binder resin in the binder resin particles, while agitating a dispersion containing the aggregated particles, an agitating rotation speed in the agitation of the dispersion is decreased in a stepwise manner or in a continuous manner.

### BRIEF DESCRIPTION OF THE DRAWINGS

Exemplary embodiment(s) of the present invention will be described in detail based on the following figures, wherein:

FIG. 1 is a view schematically showing a configuration of an example of an image forming apparatus used in the present exemplary embodiment; and

FIG. 2 is a view schematically showing a configuration of an example of a process cartridge used in the present exemplary embodiment.

### DETAILED DESCRIPTION

Hereinafter, exemplary embodiments of the present invention will be described in detail with reference to the accompanying drawings.

Regarding the numerical ranges described in stages, the upper limit value or lower limit value of a numerical range may be replaced with the upper limit value or lower limit value of another numerical range described in stages.

In addition, the upper limit value or lower limit value of a numerical range may be replaced with values described in Examples.

In a case where, as an amount of each component in a composition, there are two or more kinds of substances corresponding to each component in the composition, unless otherwise specified, the amount of each component means the total amount of two or more kinds of the substances present in the composition.

The term “step” includes not only an independent step but a step that is not clearly distinguished from other steps as long as the intended purpose of the step is achieved.

### Manufacturing Method of Electrostatic Charge Image Developing Toner

The manufacturing method of an electrostatic charge image developing toner according to the present exemplary embodiment includes a step of aggregating particles including binder resin particles in a dispersion to form aggregated particles and a step of heating the aggregated particles to raise a temperature of the aggregated particles and fuse the aggregated particles, in which, in the fusing step, after raising the temperature to equal to or higher than a glass transition temperature of a binder resin in the binder resin particles, while agitating a dispersion containing the aggregated particles, an agitating rotation speed in the agitation of the dispersion is decreased in a stepwise manner or in a continuous manner.

In addition, an electrostatic charge image developing toner according to the present exemplary embodiment is a toner manufactured by the manufacturing method of an electrostatic charge image developing toner according to the present exemplary embodiment.

A manufacturing method of a toner includes a wet manufacturing method, and for example, a manufacturing method of a toner, in which binder resin particles or release agent particles are aggregated using an aggregating agent such as a metal salt, and the obtained aggregated particles are heated and fused, has been known.

In the manufacturing method of a toner according to the related art, in which the toner is manufactured by aggregation and fusion of particles, there is a problem that, due to the contact between the particles such as the aggregated particles by agitation, the stress due to the agitation, and more specifically, the increase in number of contacts between the particles and the increase in proximity velocity of the particles, the particles come into contact with each other, and thus coarse powder is generated.

In the manufacturing method of an electrostatic charge image developing toner according to the present exemplary embodiment, in the fusing step, it is presumed that the generation of coarse particles is suppressed as follows by raising a temperature to equal to or higher than a glass transition temperature of the binder resin, and then agitating a dispersion containing the aggregated particles while stepwise or continuously decreasing an agitating rotation speed in the agitation of the dispersion.

In a case where the temperature is raised to equal to or higher than the glass transition temperature of the binder resin in the first half of the fusing step, the binder resin particles in the aggregated particles are hardened, so that the coarse powder can be reduced by a deflocculating force of the agitation; but in a case where the temperature is raised to equal to or higher than the glass transition temperature in the second half of the fusing step, the particles such as the aggregation particles and the fused toner particles are softened, so that the generation of the coarse powder can be suppressed by decreasing the agitating rotation speed. As a result, the generation of the coarse particles is suppressed.

Hereinafter, each of the steps will be described in detail.

### Aggregated Particle-Forming Step

The manufacturing method of an electrostatic charge image developing toner according to the present exemplary embodiment includes a step of aggregating particles including binder resin particles in a dispersion to form aggregated particles.

The above-described dispersion may contain, as necessary, particles such as colorant particles and release agent particles, in addition to the binder resin particles.

In addition, for example, the binder resin particles preferably include amorphous resin particles and crystalline resin particles.

The binder resin in the binder resin particles is not particularly limited, but is preferably a polyester resin.

In the manufacturing method of an electrostatic charge image developing toner according to the present exemplary embodiment, a proportion of the crystalline resin included in the binder resin of the obtained toner particles is not limited, but from the viewpoint of suppression of the generation of the coarse particles, the proportion of the crystalline resin included in the binder resin of the obtained toner particles is preferably 15% by mass or more and 50% by mass or less, and more preferably 20% by mass or more and 40% by mass or less.

In the manufacturing method of an electrostatic charge image developing toner according to the present exemplary embodiment, a proportion of the crystalline polyester resin included in the binder resin of the obtained toner particles is not limited, but from the viewpoint of suppression of the generation of the coarse particles, the proportion of the crystalline polyester resin included in the binder resin of the obtained toner particles is preferably 15% by mass or more and 50% by mass or less, and more preferably 20% by mass or more and 40% by mass or less.

The above-described dispersion is, for example, suitably prepared by mixing an amorphous resin particle dispersion, a crystalline resin particle dispersion, a colorant particle dispersion, and a release agent particle dispersion.

In the above-described dispersion, for example, it is preferable to form aggregated particles including amorphous resin particles, crystalline resin particles, colorant particles, and release agent particles, that have a radius close to a radius of the toner particles to be obtained by hetero-aggregating the amorphous resin particles, the crystalline resin particles, the colorant particles, and the releasing agent particles.

Specifically, for example, an aggregating agent is added to the dispersion, the pH of the dispersion is adjusted such that the dispersion is acidic (for example, pH of 2 or more and 5 or less), and a dispersion stabilizer is added thereto as necessary. Thereafter, the dispersion is heated to a temperature of the glass transition temperature of the resin particles (specifically, for example, to a temperature equal to or higher than the glass transition temperature of the resin particles −30° C. and equal to or lower than the glass transition temperature of the resin particles −10° C.) such that the particles dispersed in the mixed dispersion are aggregated, thereby forming aggregated particles.

In the above-described aggregated particle-forming step, for example, in a state where the dispersion is agitated with a rotary shearing homogenizer, the above-described aggregating agent may be added thereto at room temperature (for example, 25° C.), the pH of the dispersion may be adjusted such that the dispersion is acidic (for example, pH of 2 or more and 5 or less), a dispersion stabilizer may be added to the dispersion as necessary, and then the dispersion may be heated.

Examples of the aggregating agent include a surfactant having polarity opposite to the polarity of the surfactant used as a dispersant added to the dispersion, an inorganic metal salt, and a metal complex having a valency of 2 or higher. In particular, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added with respect to 100 parts by mass of the amorphous resin particles is, for example, preferably 0.01 parts by mass or more and 5.0 parts by mass or less, and more preferably 0.1 parts by mass or more and less than 3.0 parts by mass.

Aspects of the respective components contained in the toner particles, such as the binder resin, the release agent, and the colorant, will be collectively described later.

### Fusing Step

The manufacturing method of an electrostatic charge image developing toner according to the present exemplary embodiment includes a step of heating the aggregated particles to raise a temperature of the aggregated particles and fuse the aggregated particles, in which, in the fusing step, after raising the temperature to equal to or higher than a glass transition temperature of a binder resin in the binder resin particles, while agitating a dispersion containing the aggregated particles, an agitating rotation speed in the agitation of the dispersion is decreased in a stepwise manner or in a continuous manner.

In the above-described fusing step, the aggregated particle dispersion in which the aggregated particles are dispersed is heated to, for example, equal to or higher than the glass transition temperature of the binder resin particles, preferably equal to or higher than the glass transition temperature of the binder resin particles and equal to or lower than (the glass transition temperature of the binder resin particles +40° C.), and more preferably equal to or higher than (the glass transition temperature of the binder resin particles +10° C.) and equal to or lower than (the glass transition temperature of the binder resin particles +30° C.), thereby fusing the aggregated particles and forming the toner particles.

In the above-described fusing step, the temperature is raised to equal to or higher than the glass transition temperature of the binder resin in the binder resin particles described above, and then the agitating rotation speed in the agitation of the dispersion described above is decreased in a stepwise manner or in a continuous manner.

From the viewpoint of suppression of the generation of the coarse particles, a decrease proportion of the above-described agitating rotation speed (=(Initial agitating rotation speed-Agitating rotation speed after decrease)/Initial agitating rotation speed×100) is, for example, preferably 28% or more, more preferably 48% or more, still more preferably 48% or more and 95% or less, and particularly preferably 60% or more and 90% or less.

The above-described initial agitating rotation speed is an agitating rotation speed at a point in time at which the temperature has been raised to equal to or higher than the glass transition temperature of the binder resin.

In the present exemplary embodiment, the above-described fusing step is set to a period from a start point of raising the temperature of the above-described dispersion to a temperature equal to or higher than the glass transition temperature of the binder resin to a point in time at which the dispersion is cooled to a temperature lower than the glass transition temperature of the binder resin.

In the above-described fusing step, from the viewpoint of fusing particle formability, for example, it is preferable to maintain the initial agitating rotation speed for 10 minutes or more after the completion of the temperature rise of the dispersion to the temperature equal to or higher than the glass transition temperature of the binder resin; more preferably to maintain the initial agitating rotation speed for 20 minutes or more after the completion; still more preferably to maintain the initial agitating rotation speed for 30 minutes or more and 240 minutes or less after the completion; and particularly preferably to maintain the initial agitating rotation speed for 30 minutes or more and 120 minutes or less after the completion.

In addition, in the above-described fusing step, from the viewpoint of suppression of the generation of the coarse particles, for example, it is preferable to lower the agitating rotation speed in a stepwise or continuous manner, and then maintain the lowered agitating rotation speed for 10 minutes or more; more preferably maintain the lowered agitating rotation speed for 20 minutes or more; still more preferably maintain the lowered agitating rotation speed for 30 minutes or more and 300 minutes or less; and particularly preferably maintain the lowered agitating rotation speed for 30 minutes or more and 240 minutes or less.

In the above-described fusing step, for example, it is preferable to gradually decrease the agitating rotation speed.

In a case where the agitating rotation speed is decreased in a stepwise manner, it is sufficient that the number of times of decreasing the agitating rotation speed is 1 or more, but from the viewpoint of suppression of the generation of the coarse particles, for example, the number of times is preferably 1 or more and 5 or less, more preferably 1 or more and 3 or less, and particularly preferably 1 or 2.

In a case where the agitating rotation speed is decreased in a continuous manner, from the viewpoint of suppression of the generation of the coarse particles, for example, the rate at which the agitating rotation speed is decreased is preferably 0.1 revolutions per minute (rpm)/(m³·h) or more and 10 rpm/(m³·h) or less, and more preferably 0.5 rpm/(m³·h) or more and 5.0 rpm/(m³·h) or less.

In the above-described fusing step, from the viewpoint of suppression of the generation of the coarse particles, an agitating rotation speed per unit volume in the agitation of the dispersion described above is, for example, preferably 0.1 rpm/m³ or more and 8.0 rpm/m³ or less, more preferably 0.2 rpm/m³ or more and 6.0 rpm/m³ or less, and particularly preferably 0.3 rpm/m³ or more and 5.0 rpm/m³ or less.

In addition, in the above-described fusing step, from the viewpoint of suppression of the generation of the coarse particles, an agitating rotation speed per unit volume decreasing the agitating rotation speed is, for example, preferably 0.05 rpm/m³ or more and 3.0 rpm/m³ or less, more preferably 0.1 rpm/m³ or more and 2.5 rpm/m³ or less, still more preferably 0.3 rpm/m³ or more and 2.5 rpm/m³ or less, and particularly preferably 0.3 rpm/m³ or more and 2.0 rpm/m³ or less.

The “agitating rotation speed per unit volume” in the present exemplary embodiment is a value obtained by dividing a rotation speed of the agitating blade by a volume of the dispersion in an agitated vessel.

In the above-described fusing step, from the viewpoint of suppression of the generation of the coarse particles, a pH of the dispersion is, for example, preferably 6 or more and 10 or less, more preferably 6.5 or more and 9 or less, and particularly preferably 7.0 or more and 8.5 or less.

In the above-described fusing step, from the viewpoint of pH adjustment, for example, it is preferable to add an acidic aqueous solution to the above-described dispersion, and from the viewpoint of suppression of the generation of the coarse particles, it is more preferable to stepwise or continuously add an acidic aqueous solution to the dispersion.

From the viewpoint of particle formability and suppression of the generation of the coarse particles, the addition of the acidic aqueous solution in the above-described fusing step is, for example, preferably performed after the temperature is raised to equal to or higher than the glass transition temperature of the binder resin in the binder resin particles described above, and more preferably performed after the above-described agitating rotation speed is decreased.

From the viewpoint of suppression of the generation of the coarse particles, a change rate of the pH of the above-described dispersion in the above-described fusing step is, for example, preferably 3.0/min or less, more preferably 1.5/min or less, and particularly preferably 0.8/min or less.

The acidic aqueous solution may be an aqueous solution of an inorganic acid or an aqueous solution of an organic acid, and is preferably an aqueous solution of an inorganic acid and more preferably an aqueous solution of nitric acid.

### Agitation Equipment

An agitation equipment used in the aggregated particle-forming step and the fusing step described above is not particularly limited, and a known agitation equipment is used, and suitable examples thereof include a granulating container (agitated vessel) having a temperature control mechanism such as a jacket, and an agitation equipment having an agitating blade.

The agitating blade is not particularly limited, and examples thereof include a propeller type, an anchor type, a paddle type, and a turbine type.

In addition, in the above-described agitation equipment, in a case where an agitating blade diameter is represented by d (m) and a granulating container inner diameter is represented by D (m), a value of d/D is, for example, preferably 0.3 or more and 0.8 or less, and more preferably 0.5 or more and 0.7 or less.

Furthermore, in the above-described agitation equipment, from the viewpoint of further exhibiting the effect in the present exemplary embodiment, the agitating blade diameter d is, for example, preferably 0.2 m or more, and more preferably 0.3 m or more.

The manufacturing method of an electrostatic charge image developing toner according to the present exemplary embodiment may further include a known step other than the aggregated particle-forming step and the fusing step described above. Specific examples thereof include the following steps.

In addition, for example, the manufacturing method of an electrostatic charge image developing toner according to the exemplary embodiment preferably includes a preparing step of preparing toner particles containing an amorphous resin.

Specifically, for example, the manufacturing method of an electrostatic charge image developing toner according to the present exemplary embodiment preferably includes a step of preparing a non-crystalline resin particle dispersion in which non-crystalline resin particles are dispersed and a crystalline resin particle dispersion in which crystalline resin particles are dispersed (resin particle dispersion-preparing step); the above-described aggregated particle-forming step; a step of obtaining an aggregated particle dispersion in which the aggregated particles are dispersed, mixing the aggregated particle dispersion and the amorphous resin particle dispersion with each other, and aggregating the amorphous resin particles adhering to the surface of the aggregated particles to form second aggregated particles (second aggregated particle-forming step); a step of adjusting the pH of the dispersion to stop the progress of the aggregation (aggregation stopping step); and the above-described fusing step.

Hereinafter, each of the steps will be specifically described.

In the following section, a method for obtaining toner particles containing a colorant and a release agent will be described. The colorant and the release agent are used as necessary. Naturally, other additives different from the colorant and the release agent may also be used.

### Resin Particle Dispersion-Preparing Step

First, for example, a colorant particle dispersion in which colorant particles are dispersed and a release agent particle dispersion in which release agent particles are dispersed are prepared together with the respective resin particle dispersions (the amorphous resin particle dispersion and the crystalline resin particle dispersion) in which the respective resin particles to be the binder resin are dispersed.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having a medium, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase inversion) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and even more preferably 0.1 μm or more and 0.6 μm or less.

For determining the volume-average particle size of the resin particles, a particle size distribution is measured using a laser diffraction type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant particle dispersion and a release agent particle dispersion are prepared in the same manner as that adopted for preparing the resin particle dispersion. That is, the volume-average particle size of the particles, the dispersion medium, the dispersion method, and the content of the particles in the resin particle dispersion are also applied to the colorant particles to be dispersed in the colorant particle dispersion and the release agent particles to be dispersed in the release agent particle dispersion.

### Second Aggregated Particle-Forming Step

After obtaining the aggregated particle dispersion in which the above-described aggregated particles are dispersed, the aggregated particle dispersion and the amorphous resin particle dispersion are mixed with each other.

In a dispersion medium in which the aggregated particles and the amorphous resin particles described above are dispersed, the amorphous resin particles are aggregated on a surface of the aggregated particles.

Specifically, for example, in the above-described aggregated particle-forming step, in a case where the aggregated particles have reached a target particle size, the dispersion of the amorphous resin particles is added to the amorphous resin particle dispersion, and the dispersion is heated at a temperature equal to or lower than a glass transition temperature of the amorphous resin particles.

Next, the pH of the dispersion is adjusted to stop the progress of the aggregation (aggregation stopping step).

After the above-described fusing step, the toner particles formed in a solution undergo a known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

For example, it is preferable that the manufacturing method of an electrostatic charge image developing toner according to the present exemplary embodiment includes a step of adding an external additive to the obtained toner particles.

The external addition method may be performed, for example, using a V blender, a Henschel mixer, a Lödige mixer, or the like. Furthermore, coarse particles of the toner may be removed as necessary by using a vibratory sieving machine, a pneumatic sieving machine, or the like.

Hereinafter, each component contained in the electrostatic charge image developing toner obtained by the manufacturing method of an electrostatic charge image developing toner according to the present exemplary embodiment will be described in detail.

### Binder Resin

For example, the binder resin preferably contains an amorphous resin, and from the viewpoint of image intensity and viewpoint of suppressing density unevenness in an image to be obtained, it is more preferable to contain an amorphous resin and a crystalline resin. That is, in the above-described aggregated particle-forming step, for example, it is more preferable that the above-described binder resin particles contain amorphous resin particles and crystalline resin particles.

In addition, for example, it is preferable that the above-described toner particles contain an amorphous resin.

Furthermore, for example, it is preferable that the above-described toner particles are core-shell type toner particles.

Here, the amorphous resin means a resin that shows only a stepwise change in amount of heat absorbed instead of having a clear endothermic peak in a case where the resin is measured by a thermoanalytical method using differential scanning calorimetry (DSC), and stays as a solid at room temperature but turns thermoplastic at a temperature equal to or higher than a glass transition temperature.

On the other hand, the crystalline resin means a resin having a clear endothermic peak instead of showing a stepwise change in endothermic amount, in differential scanning calorimetry (DSC).

Specifically, for example, the crystalline resin refers to a resin that has a half-width of an endothermic peak of 10° C. or less in a case where the resin is measured at a temperature rising rate of 10° C./min, and the amorphous resin refers to a resin that has a half-width of more than 10° C. or a resin for which a clear endothermic peak is not observed.

The amorphous resin will be described.

Examples of the amorphous resin include known amorphous resins such as an amorphous polyester resin, an amorphous vinyl resin (such as a styrene acrylic resin), an epoxy resin, a polycarbonate resin, and a polyurethane resin. Among the examples, from the viewpoint of suppressing density unevenness and whitened spots in the image to be obtained, for example, an amorphous polyester resin or an amorphous vinyl resin (particularly, a styrene acrylic resin) is preferable, and an amorphous polyester resin is more preferable.

For example, using an amorphous polyester resin and a styrene acrylic resin in combination as the amorphous resin is also a preferable aspect.

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among the above, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having a valency of 3 or more and a crosslinked structure or a branched structure may be used in combination with a diol. Examples of the polyhydric alcohol having a valency of 3 or more include glycerin, trimethylolpropane, and pentaerythritol.

One kind of polyhydric alcohol may be used alone, or two or more kinds of polyhydric alcohols may be used in combination.

The amorphous polyester resin is obtained by a known manufacturing method.

Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation. In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the copolymerization reaction, for example, the monomer with poor compatibility may be condensed in advance with an acid or an alcohol that is to be polycondensed with the monomer, and then polycondensed with the main component.

A proportion of the amorphous resin in all binder resins is, for example, preferably 60% by mass or more and 98% by mass or less, more preferably 65% by mass or more and 95% by mass or less, and still more preferably 70% by mass or more and 90% by mass or less.

Characteristics of the amorphous resin will be described.

A glass transition temperature (Tg) of the amorphous resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

A weight-average molecular weight (Mw) of the amorphous resin is, for example, preferably 5,000 or more and 1,000,000 or less, and more preferably 7,000 or more and 500,000 or less.

A number-average molecular weight (Mn) of the amorphous resin is, for example, preferably 2,000 or more and 100,000 or less.

A molecular weight distribution Mw/Mn of the amorphous resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC⋅HLC-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

From the viewpoint of suppression of the generation of the coarse particles, as the amorphous polyester resin, for example, it is preferable to use a polyester resin having a weight-average molecular weight of 5,000 or more and 20,000 or less and a polyester resin having a weight-average molecular weight of more than 20,000 and 1,000,000 or less in combination; it is more preferable to use a polyester resin having a weight-average molecular weight of 7,000 or more and 20,000 or less and a polyester resin having a weight-average molecular weight of more than 20,000 and 500,000 or less in combination; and it is particularly preferable to use a polyester resin having a weight-average molecular weight of 7,000 or more and 20,000 or less and a polyester resin having a weight-average molecular weight of more than 20,000 and 100,000 or less in combination.

The crystalline resin will be described.

Examples of the crystalline resin include known crystalline resins such as a crystalline polyester resin, and a crystalline vinyl resin (such as a polyalkylene resin and a long-chain alkyl (meth)acrylate resin). Among the examples, from the viewpoint of suppressing density unevenness and whitened spots in the image to be obtained, for example, a crystalline polyester resin is preferable.

Examples of the crystalline polyester resin include a polycondensate of polyvalent carboxylic acid and polyhydric alcohol. As the crystalline polyester resin, a commercially available product or a synthetic resin may be used.

Since the crystalline polyester resin easily forms a crystal structure, the crystalline polyester resin is, for example, preferably a polycondensate formed of a linear aliphatic polymerizable monomer than a polycondensate formed of a polymerizable monomer having an aromatic ring.

Examples of the polyvalent carboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the aliphatic diols, for example, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

The content of the aliphatic diol in the polyhydric alcohol may be 80% by mole or more and, for example, preferably 90% by mole or more.

A melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature of the crystalline polyester resin is determined from a DSC curve obtained by differential scanning calorimetry (DSC) by “peak melting temperature” described in the method for determining the melting temperature in JIS K7121: 1987, “Testing methods for transition temperatures of plastics”.

The weight-average molecular weight (Mw) of the crystalline polyester resin is, for example, preferably 6,000 or more and 35,000 or less.

The crystalline polyester resin can be obtained by a known manufacturing method, for example, same as the amorphous polyester resin.

As the crystalline polyester resin, from the viewpoint that a crystal structure is easily formed and compatibility with the amorphous polyester resin is favorable so that fixability of the image is improved, a polymer of an α,ω-linear aliphatic dicarboxylic acid and an α,ω-linear aliphatic diol is preferable.

As the α,ω-linear aliphatic dicarboxylic acid, for example, an α,ω-linear aliphatic dicarboxylic acid having an alkylene group that links two carboxy groups and has 3 or more and 14 or less carbon atoms is preferable, and the number of carbon atoms in the alkylene group is more preferably 4 or more and 12 or less, and still more preferably 6 or more and 10 or less.

Examples of the α,ω-linear aliphatic dicarboxylic acid include succinic acid, glutaric acid, adipic acid, 1,6-hexanedicarboxylic acid (common name: suberic acid), 1,7-heptanedicarboxylic acid (common name: azelaic acid), 1,8-octanedicarboxylic acid (common name: sebacic acid), 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; and among these, for example, 1,6-hexanedicarboxylic acid, 1,7-heptanedicarboxylic acid, 1,8-octanedicarboxylic acid, 1,9-nonanedicarboxylic acid, or 1,10-decanedicarboxylic acid is preferable.

One α,ω-linear aliphatic dicarboxylic acid may be used alone, or two or more α,ω-linear aliphatic dicarboxylic acids may be used in combination.

As the α,ω-linear aliphatic diol, for example, an α,ω-linear aliphatic diol having an alkylene group that links two hydroxy groups and has 3 or more and 14 or less carbon atoms is preferable, and the number of carbon atoms in the alkylene group is more preferably 4 or more and 12 or less, and still more preferably 6 or more and 10 or less.

Examples of the α,ω-linear aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,14-tetradecanediol, and 1,18-octadecanediol; and among these, 1,6-hexanediol, 1,7-heptanediol, 1,8-octanediol, 1,9-nonanediol, or 1,10-decanediol is preferable.

One α,ω-linear aliphatic diol may be used alone, or two or more α,ω-linear aliphatic diols may be used in combination.

As the polymer of the α,ω-linear aliphatic dicarboxylic acid and the α,ω-linear aliphatic diol, from the viewpoint that a crystal structure is easily formed and compatibility with the amorphous polyester resin is favorable so that fixability of the image is improved, for example, a polymer of at least one selected from the group consisting of 1,6-hexanedicarboxylic acid, 1,7-heptanedicarboxylic acid, 1,8-octanedicarboxylic acid, 1,9-nonanedicarboxylic acid, and 1,10-decanedicarboxylic acid and at least one selected from the group consisting of 1,6-hexanediol, 1,7-heptanediol, 1,8-octanediol, 1,9-nonanediol, and 1,10-decanediol is preferable; and among these, for example, a polymer of 1,10-decanedicarboxylic acid and 1,6-hexanediol is more preferable.

### Other Binder Resins

Examples of the binder resin include homopolymers of monomers such as ethylenically unsaturated nitriles (such as acrylonitrile and methacrylnitrile), vinyl ethers (such as vinyl methyl ether and vinyl isobutyl ether), vinyl ketones (such as vinyl methyl ketone, vinyl ethyl ketone, and vinyl isopropenyl ketone), and olefins (such as ethylene, propylene, and butadiene), and copolymers obtained by combining two or more of such monomers.

Examples of other binder resins include non-vinyl-based resins such as an epoxy resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

The content of the binder resin with respect to the total amount of the toner particles is, for example, preferably 40% by mass or more and 95% by mass or less, more preferably 50% by mass or more and 90% by mass or less, and even more preferably 60% by mass or more and 85% by mass or less.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

As the release agent, from the viewpoint of suppressing density unevenness and whitened spots in the image to be obtained, and viewpoint that compatibility with the amorphous polyester resin is favorable so that fixability of the image is improved, for example, an ester wax is preferable; and an ester wax of a higher fatty acid having 10 or more and 30 or less carbon atoms and a monovalent or polyvalent alcohol component having 1 or more and 30 or less carbon atoms is more preferable.

The ester wax is a wax having an ester bond. The ester wax may be any of a monoester, a diester, a triester, or a tetraester, and a known natural or synthetic ester wax can be adopted.

Examples of the ester wax include an ester compound of a higher fatty acid (such as a fatty acid having 10 or more carbon atoms) and a monohydric or polyhydric aliphatic alcohol (such as an aliphatic alcohol having 8 or more carbon atoms), that has a melting temperature of 60° C. or higher and 110° C. or lower (for example, preferably 65° C. or higher and 100° C. or lower and more preferably 70° C. or higher and 95° C. or lower).

Examples of the ester wax include an ester compound of a higher fatty acid (caprylic acid, capric acid, lauric acid, myristic acid, palmitic acid, stearic acid, arachidic acid, behenic acid, or oleic acid) and an alcohol (a monohydric alcohol such as methanol, ethanol, propanol, isopropanol, butanol, capryl alcohol, lauryl alcohol, myristyl alcohol, cetyl alcohol, stearyl alcohol, or oleyl alcohols; or a polyhydric alcohol such as glycerin, ethylene glycol, propylene glycol, sorbitol, or pentaerythritol), and specific examples thereof include carnauba wax, rice wax, candelilla wax, jojoba oil, wood wax, beeswax, insect wax, lanolin, and montanic acid ester wax.

The melting temperature of the release agent is, for example, preferably 50° C. or higher and 110° C. or lower, and more preferably 60° C. or higher and 100° C. or lower.

The melting temperature of the release agent is determined from a DSC curve obtained by differential scanning calorimetry (DSC) by “peak melting temperature” described in the method for determining the melting temperature in JIS K 7121:1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Colorant

In the above-described aggregation step, for example, it is preferable that the dispersion further contains colorant particles.

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

One kind of colorant may be used alone, or two or more kinds of colorants may be used in combination.

As the colorant, a colorant having undergone a surface treatment as necessary may be used, or a dispersant may be used in combination with the colorant. In addition, a plurality of kinds of colorants may be used in combination.

The content of the colorant with respect to the total amount of the toner particles is, for example, preferably 1% by mass or more and 30% by mass or less, and more preferably 3% by mass or more and 15% by mass or less.

### Other Additives

Examples of other additives include well-known additives such as a magnetic material, a charge control agent, and inorganic powder. The additives are incorporated into the toner particles as internal additives.

### Characteristics and the Like of Toner Particles

The toner particles may be toner particles (core-shell type particles) having a so-called core-shell structure in which a core portion (core particle) and a coating layer (shell layer) that coats the core portion are provided. For example, the toner particles having a core-shell structure may be configured to a core portion containing the binder resin and a colorant, a release agent, or the like as necessary, and a coating layer containing the binder resin.

In a case of the toner particles having a core-shell structure, from the viewpoint of suppressing deformation of the toner particles, an average thickness of the shell layer is, for example, preferably 120 nm or more, more preferably 130 nm or more, and still more preferably 140 nm or more; and is preferably 550 nm or less, more preferably 500 nm or less, and still more preferably 400 nm or less.

The average thickness of the shell layer is measured by the following method.

The toner particles are embedded in an epoxy resin and sliced with a diamond knife or the like, and the prepared slices are stained with osmium tetroxide or ruthenium tetroxide in a desiccator. The stained slices are observed with a scanning electron microscope (SEM). Cross sections of 10 toner particles are randomly selected from the SEM image, and then for one toner particle, the thickness of the shell layer is measured at 20 positions, and the average value thereof is calculated. The average value of the 10 toner particles is adopted as the average thickness.

The volume-average particle size (D50v) of the toner is, for example, preferably 2 μm or more and 10 μm or less, and more preferably 4 μm or more and 8 μm or less.

The volume-average particle size of the toner is measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 mL of a 5% by mass aqueous solution of a surfactant (for example, preferably sodium alkylbenzene sulfonate) as a dispersant. The obtained solution is added to an electrolytic solution in a volume of 100 mL or more and 150 mL or less.

The electrolytic solution in which the sample is suspended is subjected to a dispersion treatment for 1 minute with an ultrasonic disperser, and each particle size of particles having a particle size in a range of 2 μm or more and 60 μm or less is measured using COULTER MULTISIZER II with an aperture having an aperture size of 100 μm. The number of particles to be sampled is set to 50,000.

For the measured particle size, a volume-based cumulative distribution is drawn from the small size side, and a particle size at which the cumulative percentage is 50% is defined as the volume-average particle size D50v.

An average circularity of the toner particles in the present exemplary embodiment is not particularly limited, but from the viewpoint of improving cleaning property of the toner from the image holder, the average circularity is preferably 0.91 or more and 0.98 or less, more preferably 0.94 or more and 0.98 or less, and still more preferably 0.95 or more and 0.97 or less.

In the present exemplary embodiment, the circularity of the toner particles is calculated by (perimeter of circle having the same area as projected image of particle)÷(perimeter of projected image of particle). In a circularity distribution, the circularity below which the cumulative percentage of particles having circularity lower than this circularity reaches 50% is defined as the average circularity of the toner particles. The average circularity of the toner particles is determined by analyzing at least 3,000 toner particles with a flow-type particle image analyzer.

The average circularity of the toner particles can be controlled, for example, by adjusting the agitating speed of the dispersion, the temperature of the dispersion, or the retention time in the fusion step.

In addition, the amount of the release agent on the surface of the toner particles can be controlled, for example, by adjusting the amount of the release agent to be charged, the type of the release agent, the temperature during melting and kneading, and the surface treatment with hot air after pulverization.

### External Additive

The toner manufactured by the manufacturing method of an electrostatic charge image developing toner according to the present exemplary embodiment may contain an external additive as necessary.

In addition, the toner manufactured by the manufacturing method of an electrostatic charge image developing toner according to the present exemplary embodiment may be toner particles having no external additive, or may be toner particles to which an external additive is added.

Examples of the external additive include inorganic particles. Examples of the above-described inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

The amount of the hydrophobic agent is, for example, preferably 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 10% by mass or less, and more preferably 0.01% by mass or more and 6% by mass or less.

### Electrostatic Charge Image Developer

The electrostatic charge image developer according to the present exemplary embodiment contains at least the toner manufactured by the manufacturing method of an electrostatic charge image developing toner according to the present exemplary embodiment.

The electrostatic charge image developer according to the present exemplary embodiment may be a one-component developer that contains only the toner manufactured by the manufacturing method of an electrostatic charge image developing toner according to the present exemplary embodiment, or a two-component developer that is obtained by mixing the toner with a carrier.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating a core material, which is particles configuring the above-described carrier, with a coating resin.

Examples of the magnetic powder include magnetic metals such as iron, nickel, and cobalt; and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene/acrylic acid ester copolymer, a straight silicone resin configured with an organosiloxane bond, a product obtained by modifying the straight silicone resin, a fluororesin, polyester, polycarbonate, a phenol resin, and an epoxy resin.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, which are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer, a spray method of spraying the solution for forming a coating layer to the surface of the core material, a fluidized bed method of spraying the solution for forming a coating layer to the core material that is floating by an air flow, and a kneader coater method of mixing the core material of the carrier with the solution for forming a coating layer in a kneader coater and then removing solvents.

The mixing ratio (mass ratio) between the toner and the carrier, represented by toner:carrier, in the two-component developer is, for example, preferably 1:100 to 30:100, and more preferably 3:100 to 20:100.

### Image Forming Apparatus and Image Forming Method

The image forming apparatus/image forming method according to the present exemplary embodiment will be described.

The image forming apparatus according to the present exemplary embodiment includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image using the electrostatic charge image developer, a transfer unit that transfers the toner image formed on the surface of the image holder to the surface of a recording medium, and a fixing unit that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed which has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, well-known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge erasing unit that erases charge by irradiating the surface of the image holder with charge erasing light before charging after the transfer of the toner image.

Examples thereof an image forming apparatus that includes a cleaning unit cleaning a surface of an image holder. In addition, as the cleaning unit, for example, a cleaning blade is preferable.

In the case of the intermediate transfer-type apparatus, as the transfer unit, for example, a configuration having an intermediate transfer member with surface on which the toner image is to be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium is adopted.

In the image forming apparatus according to the present exemplary embodiment, for example, a portion including the developing unit may be a cartridge structure (process cartridge) to detachable from the image forming apparatus. As the process cartridge, for example, a process cartridge is suitably used which includes a developing unit that contains the electrostatic charge image developer according to the present exemplary embodiment.

An example of the image forming apparatus according to the present exemplary embodiment will be shown below, but the present exemplary embodiment is not limited thereto. Hereinafter, among the parts shown in the drawing, main parts will be described, and others will not be described.

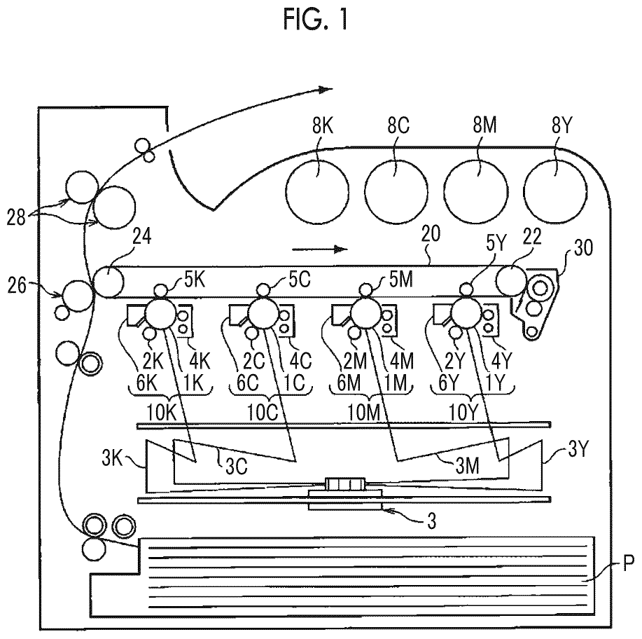

FIG. 1 is a view schematically showing the configuration of the image forming apparatus according to the present exemplary embodiment.

The image forming apparatus shown in FIG. 1 includes first to fourth image forming units 10Y, 10M, 10C, and 10K (image forming unit) adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detachable from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 which is in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. In addition, an intermediate transfer member cleaning device 30 facing the driving roll 22 is provided on the image holder surface side of the intermediate transfer belt 20.

In addition, a toner including toners having four colors of yellow, magenta, cyan, and black, that are contained in containers of toner cartridges 8Y, 8M, 8C, and 8K, is supplied to developing devices (developing units) 4Y, 4M, 4C, and 4K of the units 10Y, 10M, 10C, and 10K, respectively.

The first to fourth units 10Y, 10M, 10C, and 10K have the same configuration. Therefore, in the present specification, as a representative, the first unit 10Y will be described which is placed on the upstream side of the running direction of the intermediate transfer belt and forms a yellow image. Reference numerals marked with magenta (M), cyan (C), and black (K) instead of yellow (Y) are assigned in the same portions as in the first unit 10Y, such that the second to fourth units 10M, 10C, and 10K will not be described again.

The first unit 10Y has a photoreceptor 1Y that acts as an image holder. Around the photoreceptor 1Y, a charging roll (an example of the charging unit) 2Y that charges the surface of the photoreceptor 1Y at a predetermined potential, an exposure device (an example of the electrostatic charge image forming unit) 3 that exposes the charged surface to a laser beam 3Y based on color-separated image signals to form an electrostatic charge image, a developing device (an example of the developing unit) 4Y that develops the electrostatic charge image by supplying a charged toner to the electrostatic charge image, a primary transfer roll (an example of the primary transfer unit) 5Y that transfers the developed toner image onto the intermediate transfer belt 20, and a photoreceptor cleaning device (an example of the cleaning unit) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y. As a result, an electrostatic charge image of a yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y turns into a visible image (developed image) as a toner image by the developing device 4Y.

The developing device 4Y contains, for example, an electrostatic charge image developer that contains at least a yellow toner and a carrier. By being agitated in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 μA under the control of the control unit (not shown in the drawing).

On the other hand, the residual toner on the photoreceptor 1Y is removed by a photoreceptor cleaning device 6Y and collected.

In addition, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt 20, and a secondary transfer roll 26 (an example of a secondary transfer unit) disposed on the image holder surface side of the intermediate transfer belt 20. On the other hand, via a supply mechanism, recording paper P (an example of recording medium) is fed at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of fixing unit), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge and Toner Cartridge

The process cartridge according to the present exemplary embodiment will be described.

The process cartridge according to the present exemplary embodiment includes a developing unit that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other units, such as an image holder, a charging unit, an electrostatic charge image forming unit, and a transfer unit, as necessary.

An example of the process cartridge according to the present exemplary embodiment will be shown below, but the present exemplary embodiment is not limited thereto. Hereinafter, among the parts shown in the drawing, main parts will be described, and others will not be described.

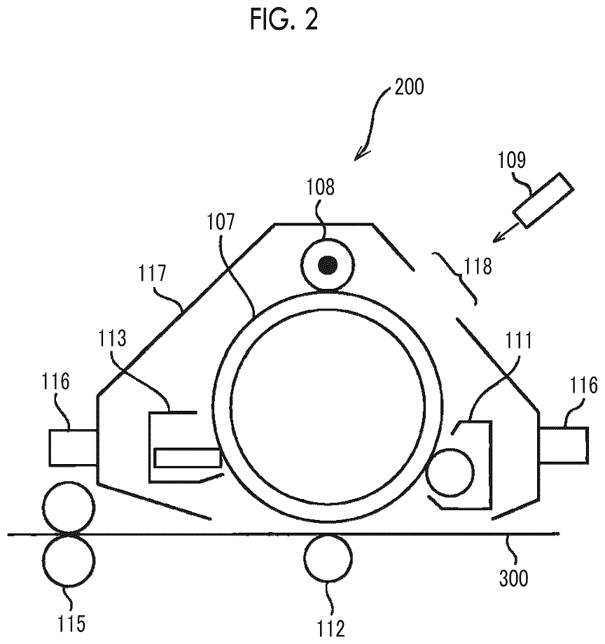

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging unit) that is provided on the periphery of the photoreceptor 107, a developing device 111 (an example of developing unit), a photoreceptor cleaning device 113 (an example of cleaning unit), that are integrally combined and held in the housing 117. The process cartridge 200 forms a cartridge in this way.

In FIG. 2, 109 indicates an exposure device (an example of electrostatic charge image forming unit), 112 indicates a transfer device (an example of transfer unit), 115 indicates a fixing device (an example of fixing unit), and 300 indicates recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing unit provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In addition, in a case where the amount of the toner contained in the container of the toner cartridge is low, the toner cartridge is replaced.

### EXAMPLES

Hereinafter, the present exemplary embodiment will be more specifically described with reference to Examples and Comparative Examples. However, the present exemplary embodiment is not limited to Examples. Unless otherwise specified, “part” and “%” showing amounts are based on mass.

### Example 1

### Preparation of Amorphous Polyester Resin (A)

Dimethyl adipate: 74 parts
Dimethyl terephthalate: 192 parts
Ethylene oxide adduct of bisphenol A: 216 parts
Ethylene glycol: 38 parts
Tetrabutoxy titanate (catalyst): 0.037 parts

The above-described components are put in a two-neck flask, nitrogen gas is introduced into the inside of the container to maintain an inert atmosphere, and the temperature is raised to 160° C. for 7 hours to carry out polycondensation with agitation, and then raised to 220° C. and maintained for 4 hours while gradually reducing the pressure to 10 Torr. The pressure is once returned to normal pressure, 9 parts of trimesic acid anhydride is added thereto, and the mixture is again gradually depressurized to 10 Torr and maintained for 1 hour to synthesize a polyester resin (A).

In a case where a glass transition temperature of the obtained polyester resin (A) is measured using a differential scanning calorimeter (DSC) by the above-described measuring method, the glass transition temperature is 65° C. In a case where a molecular weight of the obtained polyester resin (A) is measured using GPC by the above-described measuring method, the weight-average molecular weight is 12,000.

### Preparation of Amorphous Polyester Resin Particle Dispersion (A)

Polyester resin (A): 160 parts
Ethyl acetate: 233 parts
Sodium hydroxide aqueous solution (0.3 mol/L): 0.1 parts

The above-described components are put in a separable flask, heated at 70° C., and agitated with a three-one motor (manufactured by Shinto Scientific Co., Ltd.) to prepare a resin mixed solution. While further agitating the resin mixed solution, 500 parts of deionized water is gradually added thereto to carry out phase inversion emulsification, and the solvent is removed to obtain an amorphous polyester resin particle dispersion (A) (concentration of solid contents: 20%). A volume-average particle size of the resin particles in the dispersion is 160 nm.

### Preparation of Amorphous Polyester Resin (B)

Ethylene oxide (2 mol) adduct of bisphenol A: 114 parts
Propylene oxide (2 mol) adduct of bisphenol A: 84 parts
Dimethyl terephthalate: 75 parts
Dodecenyl succinic acid: 19.5 parts
Trimellitic acid: 7.5 parts

The above-described components are put in a flask equipped with an agitation equipment, a nitrogen inlet tube, a temperature sensor, and a reduced-pressure rectification tower and having an inner volume, the temperature is raised to 190° C. over 1 hour, and 3.0 parts of dibutyltin oxide is added thereto while agitating the reaction system. Furthermore, the temperature is raised from 190° C. to 240° C. over 6 hours while distilling off the generated water, and the dehydration condensation reaction is further continued at 240° C. for 2 hours to synthesize a polyester resin (B). A glass transition temperature of the obtained polyester resin (B) is 57° C., and a weight-average molecular weight thereof is 58,000.

### Preparation of Amorphous Polyester Resin Particle Dispersion (B)

Polyester resin (B): 160 parts
Ethyl acetate: 233 parts
Sodium hydroxide aqueous solution (0.3 mol/L): 0.1 parts

The above-described components are put in a separable flask, heated at 70° C., and agitated with a three-one motor (manufactured by Shinto Scientific Co., Ltd.) to prepare a resin mixed solution. While further agitating the resin mixed solution, 500 parts of deionized water is gradually added thereto to carry out phase inversion emulsification, and the solvent is removed to obtain an amorphous polyester resin particle dispersion (B) (concentration of solid contents: 20%). A volume-average particle size of the resin particles in the dispersion is 160 nm.

### Preparation of Crystalline Polyester Resin (C)

Dimethyl sebacate: 98 parts
Dimethyl 5-sulfoisophthalate sodium salt: 20 parts
1,5-Pentanediol: 100 parts
Dibutyl tin oxide (catalyst): 0.3 parts

The above-described components are put in a separable flask, air in the container is replaced with nitrogen gas by a decompression operation to be an inert atmosphere, and the mixture is agitated and refluxed at 180° C. for 5 hours with a three-one motor (manufactured by Shinto Scientific Co., Ltd.). Thereafter, the mixture is gradually heated to 230° C. under reduced pressure, agitated for 2 hours, and air-cooled at a point in time at which the mixture is viscous, and then the reaction is stopped to obtain a crystalline polyester resin (C). A weight-average molecular weight (Mw) of the obtained crystalline polyester resin (C) is 9,700.

### Preparation of Crystalline Polyester Resin Particle Dispersion (C)

Crystalline polyester resin (C): 90 parts
Anionic surfactant (manufactured by DKS Co. Ltd., NEOGEN RK): 1.8 parts
Deionized water: 210 parts

The above-described components are mixed with each other, heated to 100° C., and dispersed using a homogenizer (manufactured by IKA, ULTRA-TURRAX T50). Using a pressure jet-type Gorlin homogenizer, a dispersion treatment is performed for 1 hour, thereby obtaining a crystalline polyester resin particle dispersion having a volume-average particle size of 200 nm (concentration of solid contents: 20%).

### Preparation of Styrene Acrylic Resin Particle Dispersion(S)

Styrene: 200 parts
n-Butyl acrylate: 50 parts
Acrylic acid: 1 part
β-Carboxyethyl acrylate: 3 parts
Propanediol diacrylate: 1 part
2-Hydroxyethyl acrylate: 0.5 parts
Dodecanethiol: 1 part

A solution prepared by dissolving 4 parts of an anionic surfactant (DOWFAX manufactured by Dow Chemical Company) in 550 parts of deionized water is put in a flask, and a mixed solution obtained by mixing the above-described raw materials is added thereto and emulsified. While slowly agitating the emulsion for 10 minutes, 50 parts of deionized water in which 6 parts of ammonium persulfate is dissolved is added thereto. Next, nitrogen purging in the system is sufficiently performed, and the system is heated in an oil bath until the temperature in the system reaches 75° C. to be polymerized for 30 minutes.
Styrene: 110 parts
n-Butyl acrylate: 50 parts
β-Carboxyethyl acrylate: 5 parts
1,10-Decanediol diacrylate: 2.5 parts
Dodecanethiol: 2 parts

A mixed solution is obtained by mixing the above-described raw materials and emulsified, and the emulsion is added to the above-described flask for 120 minutes, and emulsification polymerization is continued for 4 hours. As a result, a resin particle dispersion in which resin particles having a weight-average molecular weight of 32,000, a glass transition temperature of 53° C., and a volume-average particle size of 240 nm are dispersed is obtained. Deionized water is added to the above-described resin particle dispersion to adjust the solid content to 20%, thereby obtaining a styrene acrylic resin particle dispersion(S).

### Preparation of Release Agent Particle Dispersion (W)

Paraffin wax (manufactured by NIPPON SEIRO CO., LTD., FNP 0090): 100 parts
Anionic surfactant (manufactured by DKS Co. Ltd., NEOGEN RK): 1.0 part
Poly aluminum chloride (PAC) (manufactured by Oji Paper Co., Ltd.; 30% powder product): 1.2 parts
Deionized water: 400 parts

The above-described components are mixed with each other, heated to 95° C., and dispersed using a homogenizer (manufactured by IKA, ULTRA-TURRAX T50). Using a pressure jet-type Gorlin homogenizer, a dispersion treatment is performed for 3 hours, thereby obtaining a release agent particle dispersion (W) having a volume-average particle size of 240 nm (concentration of solid contents: 20%).

### Preparation of Colorant Particle Dispersion (K)

Carbon black (manufactured by Cabot Corporation, Regal 330): 50 parts
Ionic surfactant NEOGEN RK (manufactured by DKS Co. Ltd.): 5 parts
Deionized water: 192.9 parts

The above-described components are mixed with each other and treated with ULTIMIZER (manufactured by SUGINO MACHINE LIMITED) at 240 MPa for 10 minutes, thereby preparing a colorant particle dispersion (K) (concentration of solid contents: 20% by mass).

A jacket-equipped agitated vessel in which a relationship (d/D) between a diameter d of an agitating blade (four propeller blades) and an inner diameter D of a granulating container (=agitated vessel) in a granulating step (from a step of forming aggregated particles to a step of fusing the aggregated particles) is 0.6 is prepared. The bottom of the agitated vessel is connected to a disperser (manufactured by Pacific Machinery & Engineering Co., Ltd, CAVITRON CD1010) through a pipe and a circulation pump, and a circulation type reaction vessel is formed by dipping a pipe from a discharge port of the disperser into the tank from above the agitated vessel. A material inlet in provided in a pipe line connecting the bottom of the agitated vessel and the disperser.

### Step of Forming Aggregated Particles

Deionized water: 5,000 parts
Amorphous polyester resin particle dispersion (A): 2,630 parts
Amorphous polyester resin particle dispersion (B): 2,630 parts
Crystalline polyester resin particle dispersion (C): 3,000 parts
Styrene acrylic resin particle dispersion(S): 750 parts
Release agent particle dispersion (W): 1,500 parts
Colorant particle dispersion (K): 1,500 parts

The above-described materials are put in the circulation type reaction vessel, and 0.1 N (=0.1 mol/L) nitric acid is added thereto to adjust the pH to 3.8.

15 parts of aluminum sulfate is dissolved in 1,000 parts of deionized water to prepare an aluminum sulfate aqueous solution. The aluminum sulfate aqueous solution is added to the circulation type reaction vessel from the above-described inlet during the circulation of the contents in the circulation type reaction vessel to perform the agitation and dispersion. Next, the contents are circulated for 10 minutes while maintaining the temperature of the contents at 30° C. to agitate and disperse the contents.

Next, the disperser is stopped, the bottom valve at the bottom of the agitated vessel is closed, and 3,000 parts of deionized water is added from the above-described inlet to the agitated vessel through the disperser and the pipe to be agitated and mixed with the dispersion.

Next, the contents are heated to 45° C. using a jacket while the agitation is continued, and the contents are maintained until a volume-average particle size of the aggregated particles reaches 4.0 μm.

### Second Aggregation Step

A mixed solution of 2,250 parts of the amorphous polyester resin particle dispersion (A) and 2,250 parts of the amorphous polyester resin particle dispersion (B) is put in an agitated vessel, and held for 30 minutes to obtain a dispersion containing second aggregated particles.

### Aggregation Stopping Step

20 parts of ethylenediaminetetraacetic acid (EDTA) is added to the dispersion containing the second aggregated particles. Next, a 1 N (=1 mol/L) sodium hydroxide aqueous solution is added thereto to adjust the pH to 9, and the mixture is held for 5 minutes.

### Fusing Step

While continuing the agitation in the agitated vessel, the temperature is raised to 90° C. at a temperature rising rate of 0.5° C./min, and maintained for 90 minutes (the particles are softened), and then the agitating rotation speed per unit volume is lowered from 4.0 rpm/m³ to 4.8 rpm/m³. Next, an acidic aqueous solution is intermittently added to the agitated vessel with a pH change rate ΔpH of 0.5/min, and the pH is lowered to 7.6 and maintained for 2 hours. Thereafter, the agitating rotation speed per unit volume is maintained at 1.2 rpm/m³, and the temperature is lowered to 30° C. at 5° C./min (first cooling). Next, the temperature is raised (re-heated) to 55° C. at a temperature raising rate of 0.2° C./min, maintained for 30 minutes, and then lowered to 30° C. at a cooling rate of 0.5° C./min (second cooling).

### Washing Step and Drying Step

The solid content is filtered, washed with deionized water, and dried to obtain toner particles (1) having a volume-average particle size of 5.0 μm.

### Addition of External Additive

100 parts of the obtained toner particles (1) and 1.5 parts of hydrophobic silica (RY50, manufactured by Nippon Aerosil Co., Ltd.) are mixed using a sample mill at a rotation speed of 10,000 rpm for 30 seconds. The mixture is classified using a vibration sieve with an opening of 45 μm, thereby obtaining a toner (1) (electrostatic charge image developing toner). A volume-average particle diameter of the toner (1) is 5.0 μm.

### Production of Carrier

500 parts of spherical magnetite powder particles (volume-average particle diameter: 0.55 μm) are agitated with a Henschel mixer, 5 parts of a titanate-based coupling agent is added thereto, and the mixture is heated to 100° C. and agitated for 30 minutes. Next, 6.25 parts of phenol, 9.25 parts of 35% formalin, 500 parts of magnetite particles treated with a titanate-based coupling agent, 6.25 parts of 25% aqueous ammonia, and 425 parts of water are put in a four-necked flask and agitated, and reacted at 85° C. for 120 minutes while being agitated. Thereafter, the reaction solution is cooled to 25° C., 500 parts of water is added thereto, the supernatant is removed, and the precipitate is washed with water. The precipitate washed with water is heated under reduced pressure and dried, thereby obtaining a carrier (CA) having an average particle size of 35 μm.

### Mixing of Toner and Carrier

The toner (1) and the carrier (CA) are put in a V-blender at a proportion of toner (1): carrier (CA)=5:95 (mass ratio), and agitated for 20 minutes to obtain a developer (1) (electrostatic charge image developer).

### Examples 2 to 17 and Comparative Examples 2 to 4

In Examples 2 to 13 and Comparative Examples 2 to 4, toner particles are produced in the same manner as in Example 1, except that, as shown in Table 1, the agitating rotation speed per unit volume in the fusing step, the method of changing the agitating rotation speed, the pH after the addition of the acidic aqueous solution, the pH change rate, and the temperature rise are changed.

In Example 14, toner particles are produced in the same manner as in Example 1, except that, the amount of the amorphous polyester resin particle dispersion (A) is changed to 3,230 parts, the amount of the amorphous polyester resin particle dispersion (B) is changed to 3,230 parts, and the amount of the crystalline polyester resin particle dispersion (C) is changed to 1,800 parts.

In Example 15, toner particles are produced in the same manner as in Example 1, except that, the amount of the amorphous polyester resin particle dispersion (A) is changed to 3,005 parts, the amount of the amorphous polyester resin particle dispersion (B) is changed to 3,005 parts, and the amount of the crystalline polyester resin particle dispersion (C) is changed to 2,250 parts.

In Example 16, toner particles are produced in the same manner as in Example 1, except that, the amount of the amorphous polyester resin particle dispersion (A) is changed to 3,005 parts, the amount of the amorphous polyester resin particle dispersion (B) is changed to 2,200 parts, and the amount of the crystalline polyester resin particle dispersion (C) is changed to 3,860 parts.

In Example 17, toner particles are produced in the same manner as in Example 1, except that, the amount of the amorphous polyester resin particle dispersion (A) is changed to 1,895 parts, the amount of the amorphous polyester resin particle dispersion (B) is changed to 1,895 parts, and the amount of the crystalline polyester resin particle dispersion (C) is changed to 4,470 parts.

### Comparative Example 1

Toner particles are produced in the same manner as in Example 1, except that the fusing step is changed as described below.

### Comparative Examples 5 and 6

In Comparative Example 5, toner particles are produced in the same manner as in Comparative Example 1, except that, the amount of the amorphous polyester resin particle dispersion (A) is changed to 3,230 parts, the amount of the amorphous polyester resin particle dispersion (B) is changed to 3,230 parts, and the amount of the crystalline polyester resin particle dispersion (C) is changed to 1,800 parts.

In Comparative Example 6, toner particles are produced in the same manner as in Comparative Example 1, except that, the amount of the amorphous polyester resin particle dispersion (A) is changed to 1,895 parts, the amount of the amorphous polyester resin particle dispersion (B) is changed to 1,895 parts, and the amount of the crystalline polyester resin particle dispersion (C) is changed to 4,470 parts.

### Fusing Step

The agitated vessel is heated to 90° C. at a temperature rising rate of 0.5° C./min while continuing the agitation in the agitated vessel, and the agitating rotation speed per unit volume is maintained at 5.6 rpm/m³. Next, an acidic aqueous solution is intermittently added to the agitated vessel with a pH change rate ΔpH of 2.0/min, and the pH is lowered to 6.7 and maintained for 2 hours. Thereafter, the agitating rotation speed per unit volume is maintained at 5.6 rpm/m³, and the temperature is lowered to 30° C. at 5° C./min (first cooling). Next, the temperature is raised (re-heated) to 55° C. at a temperature raising rate of 0.2° C./min, maintained for 30 minutes, and then lowered to 30° C. at a cooling rate of 0.5° C./min (second cooling).

### Particle Size Distribution Index

Regarding the volume-average particle size of the obtained toner particles, a particle size distribution of the toner particles is measured using a COULTER MULTISIZER II (manufactured by Beckman Coulter, Inc.). A volume-based cumulative distribution is drawn from the small size side, and a particle size D84v at which the cumulative percentage is 84% and a particle size D50v at which the cumulative percentage is 50% are obtained. A particle size distribution index on the large size side is calculated by dividing D50v by D84v. The results are shown in Table 1. For example, it is preferable that the value of D50v/D84v is close to 1.

### Proportion of Coarse Particles

Toner particles having a particle size of 15 μm or more are defined as coarse particles, and a volume proportion (% by volume) of the toner particles having a particle size of 15 μm or more is obtained in the particle size distribution obtained above. The results are shown in Table 1.

### Mass of Particles Adhering to Wall

After collecting attachment adhering to a wall surface of the jacket-equipped agitated vessel, the moisture is volatilized and the mass is measured. The results are shown in Table 1.

TABLE 1

| | | | Agitating | Agitating | Agitating | Agitating | Agitating |
|---|---|---|---|---|---|---|---|
| | Proportion | | rotation | rotation | rotation | rotation | rotation |
| | of crystalline | Type of | speed | speed | speed | speed | speed |
| | polyester | agitating | Before | After | After | After | Decrease |
| | resin | blade | change | change 1 | change 2 | change 3 | proportion |
| Example 1 | 28.5% | Four | 4.8 | 1.2 | Not | Not | 75% |
| | | propeller | | | changed | changed | |
| | | blades | | | | | |
| Example 2 | 28.5% | Four | 4.8 | 2.0 | Not | Not | 58% |
| | | propeller | | | changed | changed | |
| | | blades | | | | | |
| Example 3 | 28.5% | Four | 4.8 | 2.5 | Not | Not | 48% |
| | | propeller | | | changed | changed | |
| | | blades | | | | | |
| Example 4 | 28.5% | Four | 4.8 | 3.4 | Not | Not | 28% |
| | | propeller | | | changed | changed | |
| | | blades | | | | | |
| Example 5 | 28.5% | Four | 4.8 | 0.3 | Not | Not | 94% |
| | | propeller | | | changed | changed | |
| | | blades | | | | | |
| Example 6 | 28.5% | Four | 4.8 | 0.2 | Not | Not | 96% |
| | | propeller | | | changed | changed | |
| | | blades | | | | | |
| Example 7 | 28.5% | Four | 4.8 | 1.6 | 1 | 0.6 | 88% |
| | | propeller | | | | | |
| | | blades | | | | | |
| Example 8 | 28.5% | Four | 4.8 | 1.6 | 1 | 0.6 | 88% |
| | | propeller | | | | | |
| | | blades | | | | | |
| Example 9 | 28.5% | Four | 2.5 | 1.3 | Not | Not | 48% |
| | | propeller | | | changed | changed | |
| | | blades | | | | | |
| Example 10 | 28.5% | Four | 2.5 | 1.8 | Not | Not | 28% |
| | | propeller | | | changed | changed | |
| | | blades | | | | | |
| Example 11 | 28.5% | Four | 2.5 | 2.0 | Not | Not | 20% |
| | | propeller | | | changed | changed | |
| | | blades | | | | | |
| Example 12 | 28.5% | Four | 4.8 | 1.2 | Not | Not | 75% |
| | | paddle | | | changed | changed | |
| | | blades | | | | | |
| Example 13 | 28.5% | Turbine | 4.8 | 1.2 | Not | Not | 75% |
| | | blade | | | changed | changed | |
| Example 14 | 15.4% | Four | 4.8 | 1.2 | Not | Not | 75% |
| | | propeller | | | changed | changed | |
| | | blades | | | | | |
| Example 15 | 20.0% | Four | 4.8 | 1.2 | Not | Not | 75% |
| | | propeller | | | changed | changed | |
| | | blades | | | | | |
| Example 16 | 40.0% | Four | 4.8 | 1.2 | Not | Not | 75% |
| | | propeller | | | changed | changed | |
| | | blades | | | | | |
| Example 17 | 49.1% | Four | 4.8 | 1.2 | Not | Not | 75% |
| | | propeller | | | changed | changed | |
| | | blades | | | | | |
| Comparative | 28.5% | Four | 4.8 | Not | Not | Not | — |
| Example 1 | | propeller | | changed | changed | changed | |
| | | blades | | | | | |
| Comparative | 28.5% | Four | 2.5 | Not | Not | Not | — |
| Example 2 | | propeller | | changed | changed | changed | |
| | | blades | | | | | |
| Comparative | 28.5% | Four | 4.8 | Not | Not | Not | — |
| Example 3 | | paddle | | changed | changed | changed | |
| | | blades | | | | | |
| Comparative | 28.5% | Turbine | 4.8 | Not | Not | Not | — |
| Example 4 | | blade | | changed | changed | changed | |
| Comparative | 15.4% | Four | 4.8 | Not | Not | Not | — |
| Example 5 | | propeller | | changed | changed | changed | |
| | | blades | | | | | |
| Comparative | 49.1% | Four | 4.8 | Not | Not | Not | — |
| Example 6 | | propeller | | changed | changed | changed | |
| | | blades | | | | | |

| | | | pH change | | | | |
|---|---|---|---|---|---|---|---|
| | Agitating | pH after | rate in | | | Proportion | |
| | rotation | adding | adding | | | of coarse | Mass of |
| | speed | acidic | acidic | | | particles | particles |
| | Changing | aqueous | aqueous | Temperature | D50v/ | (% by | adhering |
| | method | solution | solution | rise | D84v | volume) | to wall |
| Example 1 | Stepwise | 7.6 | 0.5 | 90° C. | 1.16 | 0.30 | 0.2 |
| | manner, 1 | | | | | | |
| Example 2 | Stepwise | 7.6 | 0.5 | 90° C. | 1.21 | 0.40 | 0.3 |
| | manner, 1 | | | | | | |
| Example 3 | Stepwise | 7.6 | 0.5 | 90° C. | 1.23 | 0.50 | 0.4 |
| | manner, 1 | | | | | | |
| Example 4 | Stepwise | 7.6 | 0.5 | 90° C. | 1.25 | 0.65 | 0.5 |
| | manner, 1 | | | | | | |
| Example 5 | Stepwise | 7.6 | 0.5 | 90° C. | 1.18 | 0.50 | 1.6 |
| | manner, 1 | | | | | | |
| Example 6 | Stepwise | 7.6 | 0.5 | 90° C. | 1.18 | 0.40 | 2.1 |
| | manner, 1 | | | | | | |
| Example 7 | Stepwise | 7.3 | 0.6 | 90° C. | 1.20 | 0.55 | 0.3 |
| | manner, 3 | | | | | | |
| Example 8 | Continuous | 7.5 | 0.8 | 90° C. | 1.20 | 0.60 | 0.4 |
| | manner, 2.3 | | | | | | |
| | rpm/m³ · h | | | | | | |
| Example 9 | Stepwise | 7.5 | 0.6 | 90° C. | 1.17 | 1.10 | 1.4 |
| | manner, 1 | | | | | | |
| Example 10 | Stepwise | 7.6 | 0.6 | 90° C. | 1.20 | 1.80 | 1.0 |
| | manner, 1 | | | | | | |
| Example 11 | Stepwise | 7.7 | 0.6 | 90° C. | 1.22 | 2.30 | 0.8 |
| | manner, 1 | | | | | | |
| Example 12 | Stepwise | 7.5 | 0.8 | 90° C. | 1.18 | 0.55 | 0.4 |
| | manner, 1 | | | | | | |
| Example 13 | Stepwise | 7.6 | 0.7 | 90° C. | 1.21 | 0.80 | 0.6 |
| | manner, 1 | | | | | | |
| Example 14 | Stepwise | 6.2 | 1.3 | 95° C. | 1.21 | 1.25 | 1.2 |
| | manner, 1 | | | | | | |
| Example 15 | Stepwise | 7.1 | 1.1 | 90° C. | 1.20 | 1.15 | 1.1 |
| | manner, 1 | | | | | | |
| Example 16 | Stepwise | 8.4 | 0.9 | 87° C. | 1.20 | 1.40 | 1.4 |
| | manner, 1 | | | | | | |
| Example 17 | Stepwise | 9.1 | 0.8 | 85° C. | 1.21 | 1.50 | 1.5 |
| | manner, 1 | | | | | | |
| Comparative | — | 7.6 | 0.5 | 90° C. | 1.29 | 4.20 | 0.3 |
| Example 1 | | | | | | | |
| Comparative | — | 7.7 | 0.6 | 90° C. | 1.25 | 3.10 | 1.1 |
| Example 2 | | | | | | | |
| Comparative | — | 7.5 | 0.8 | 90° C. | 1.31 | 4.40 | 0.3 |
| Example 3 | | | | | | | |
| Comparative | — | 7.6 | 0.7 | 90° C. | 1.35 | 3.90 | 0.8 |
| Example 4 | | | | | | | |
| Comparative | — | 6.2 | 1.3 | 95° C. | 1.42 | 2.65 | 1.5 |
| Example 5 | | | | | | | |
| Comparative | — | 9.1 | 0.8 | 85° C. | 1.55 | 2.90 | 2.1 |
| Example 6 | | | | | | | |

From the above results, it is found that, in the present example, the electrostatic charge image developing toner with less generation of the coarse particles is obtained as compared with Comparative Examples.
(((1))) A manufacturing method of an electrostatic charge image developing toner, comprising:
aggregating particles including binder resin particles in a dispersion to form aggregated particles; and
heating the aggregated particles to raise a temperature of the aggregated particles and fuse the aggregated particles,
wherein, in the fusing, after raising the temperature to equal to or higher than a glass transition temperature of a binder resin in the binder resin particles, while agitating a dispersion containing the aggregated particles, an agitating rotation speed in the agitation of the dispersion is decreased in a stepwise manner or in a continuous manner.
(((2))) The manufacturing method of an electrostatic charge image developing toner according to (((1))),
wherein, in the fusing, an agitating rotation speed per unit volume in the agitation of the dispersion is 0.3 rpm/m³ or more and 5.0 rpm/m³ or less.
(((3))) The manufacturing method of an electrostatic charge image developing toner according to (((1))) or (((2))),
wherein, in the fusing, a decrease proportion of the agitating rotation speed is 28% or more.
(((4))) The manufacturing method of an electrostatic charge image developing toner according to (((3))),
wherein, in the fusing, the decrease proportion of the agitating rotation speed is 48% or more.
(((5))) The manufacturing method of an electrostatic charge image developing toner according to any one of (((1))) to (((4))),
wherein, in the fusing, an agitating rotation speed per unit volume after decreasing the agitating rotation speed is 0.3 rpm/m³ or more and 2.5 rpm/m³ or less.
(((6))) The manufacturing method of an electrostatic charge image developing toner according to any one of (((1) to
wherein, in the fusing step, a temperature of the dispersion is equal to or higher than the glass transition temperature of the binder resin and equal to or lower than (the glass transition temperature of the binder resin+40° C.).
(((7))) The manufacturing method of an electrostatic charge image developing toner according to any one of (((1))) to (6)),
wherein, in the fusing, a pH of the dispersion is 6 or more and 10 or less.
(((8))) The manufacturing method of an electrostatic charge image developing toner according to any one of (((1))) to (((7))),
wherein, in the fusing, an acidic aqueous solution is stepwise or continuously added to the dispersion.
(((9))) The manufacturing method of an electrostatic charge image developing toner according to (((8))),
wherein the addition of the acidic aqueous solution in the fusing is performed after the raising of the temperature to equal to or higher than the glass transition temperature of the binder resin in the binder resin particles.
(((10))) The manufacturing method of an electrostatic charge image developing toner according to (((8))) or ((9))), wherein a change rate of a pH of the dispersion in the fusing is 1.5/min or less.
(((11))) The manufacturing method of an electrostatic charge image developing toner according to any one of (((1))) to (((10))),
wherein a proportion of a crystalline polyester resin included in the binder resin of toner particles to be obtained is 15% by mass or more and 50% by mass or less.
(((12))) The manufacturing method of an electrostatic charge image developing toner according to (11))),
wherein the proportion of the crystalline polyester resin included in the binder resin of the toner particles to be obtained is 20% by mass or more and 40% by mass or less.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A manufacturing method of an electrostatic charge image developing toner, comprising:
aggregating particles including binder resin particles in a dispersion to form aggregated particles; and
heating the aggregated particles to raise a temperature of the aggregated particles and fuse the aggregated particles,
wherein, in the fusing, after raising the temperature to equal to or higher than a glass transition temperature of a binder resin in the binder resin particles, while agitating a dispersion containing the aggregated particles, an agitating rotation speed in the agitation of the dispersion is decreased in a stepwise manner or in a continuous manner.

2. The manufacturing method of an electrostatic charge image developing toner according to claim 1,
wherein, in the fusing, an agitating rotation speed per unit volume in the agitation of the dispersion is 0.3 rpm/m³ or more and 5.0 rpm/m³ or less.

3. The manufacturing method of an electrostatic charge image developing toner according to claim 1,
wherein, in the fusing, a decrease proportion of the agitating rotation speed is 28% or more.

4. The manufacturing method of an electrostatic charge image developing toner according to claim 3,
wherein, in the fusing, the decrease proportion of the agitating rotation speed is 48% or more.

5. The manufacturing method of an electrostatic charge image developing toner according to claim 1,
wherein, in the fusing, an agitating rotation speed per unit volume after decreasing the agitating rotation speed is 0.3 rpm/m³ or more and 2.5 rpm/m³ or less.

6. The manufacturing method of an electrostatic charge image developing toner according to claim 1,
wherein, in the fusing step, a temperature of the dispersion is equal to or higher than the glass transition temperature of the binder resin and equal to or lower than (the glass transition temperature of the binder resin+40° C.).

7. The manufacturing method of an electrostatic charge image developing toner according to claim 1,
wherein, in the fusing, a pH of the dispersion is 6 or more and 10 or less.

8. The manufacturing method of an electrostatic charge image developing toner according to claim 1,
wherein, in the fusing, an acidic aqueous solution is stepwise or continuously added to the dispersion.

9. The manufacturing method of an electrostatic charge image developing toner according to claim 8,
wherein the addition of the acidic aqueous solution in the fusing is performed after the raising of the temperature to equal to or higher than the glass transition temperature of the binder resin in the binder resin particles.

10. The manufacturing method of an electrostatic charge image developing toner according to claim 8,
wherein a change rate of a pH of the dispersion in the fusing is 1.5/min or less.

11. The manufacturing method of an electrostatic charge image developing toner according to claim 1,
wherein a proportion of a crystalline polyester resin included in the binder resin of toner particles to be obtained is 15% by mass or more and 50% by mass or less.

12. The manufacturing method of an electrostatic charge image developing toner according to claim 11,
wherein the proportion of the crystalline polyester resin included in the binder resin of the toner particles to be obtained is 20% by mass or more and 40% by mass or less.
